(19) United States
(12) Patent Application Publication
(10) Pub. No.: US 2026/0134330 A1
(43) Pub. Date: May 14, 2026

(54) SYSTEMS AND METHODS FOR ANALOG AI DEEP LEARNING

(71) Applicant: Eva Technology Corp, Boston, MA (US)

(72) Inventors: Donald Wood Loomis, III, Coppell, TX (US); Mustafa Batuhan Gundogdu, Chicago, IL (US)

(73) Assignee: Eva Technology Corp, Boston, MA (US)

(21) Appl. No.: 18/892,248

(22) Filed: Sep. 20, 2024

(51) Int. Cl. G06N 20/00; G06G 7/02

(52) U.S. Cl. CPC G06N 20/00; G06G 7/02

(57) ABSTRACT

Systems and methods are disclosed for deep learning solutions with analog AI. Analog AI systems can outperform their digital counterparts in speed and energy efficiency since computations are conducted directly in memory and analog processors inherently support parallel operations. An analog AI system may comprise a DAC, a programming module, row/column switches, a crossbar array and an ADC. The DAC provides an analog signal to the row/column switches, which along with the programming module, select a phase of operation, i.e., a forward, backward, or update path. A crossbar array is a trainable neural network that operates in the analog domain and comprises a matrix of programmable resistors, e.g., memristor devices. The crossbar array couples an output in the analog domain to the ADC. The result is a digital output from the crossbar array processing architecture.

### BACKGROUND

### A. Technical Field

The present disclosure relates generally to computer learning systems that convert an output signal from the analog domain to the digital domain. More particularly, embodiments of the present disclosure relate to systems and methods that improve power, latency and size parameters of machine learning processes by performing artificial intelligence calculations within the analog domain and converting the output to a digital signal.

### B. Background

One skilled in the art will recognize the importance and growth of machine learning applications across a variety of technologies and markets. Deep neural networks have achieved great successes in many domains, such as computer vision, natural language processing, recommender systems, etc. As technologists advance the field of machine learning, the time, energy, size and financial resources required to train increasingly complex neural network models are escalating.

Accordingly, what is needed are AI deep learning systems and methods that outperform their digital counterpart in terms of speed and energy efficiency.

A promising new domain in artificial intelligence, known as analog deep learning, offers the potential for significantly faster computation with only a fraction of the energy consumption and size of processing resources needed to implement corresponding processing devices. Analog deep learning refers to the implementation of artificial intelligence systems using analog computing principles instead of digital computing across a plurality of computational nodes within a neural network. Analog computing processes information in a continuous manner, akin to how the human brain processes information, making certain types of calculations more natural and efficient.

### BRIEF DESCRIPTION OF THE DRAWINGS

References will be made to embodiments of the disclosure, examples of which may be illustrated in the accompanying figures. These figures are intended to be illustrative, not limiting. Although the accompanying disclosure is generally described in the context of these embodiments, it should be understood that it is not intended to limit the scope of the disclosure to these particular embodiments. Items in the figures may be not to scale.

FIG. 1 depicts a generalized analog AI system, according to embodiments of the present disclosure.

FIG. 2 depicts another embodiment of the analog AI system per FIG. 1, according to embodiments of the present disclosure.

FIG. 3 and FIG. 4 depict exemplary block diagrams for asynchronous neural network training utilizing parallel processing within a crossbar network, according to various embodiments of the present disclosure.

FIG. 5 depicts a flowchart illustrating a method for parallel processing within the crossbar network, supporting a deep neural network, according to various embodiments of the present disclosure.

FIG. 6 depicts a simplified block diagram of a computing device/information handling system, according to embodiments of the present disclosure

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system/device, or a method on a tangible computer-readable medium.

Components, or modules, shown in diagrams are illustrative of exemplary embodiments of the disclosure and are meant to avoid obscuring the disclosure. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. The terms “include,” “including,” “comprise,” and “comprising” shall be understood to be open terms and any lists the follow are examples and not meant to be limited to the listed items. A “layer” may comprise one or more operations. The use of memory, database, information base, data store, tables, hardware, cache, and the like may be used herein to refer to system component or components into which information may be entered or otherwise recorded. A set may contain any number of elements, including the empty set.

In one or more embodiments, a stop condition may include: (1) a set number of iterations have been performed; (2) an amount of processing time has been reached; (3) convergence (e.g., the difference between consecutive iterations is less than a threshold value); (4) divergence (e.g., the performance deteriorates); (5) an acceptable outcome has been reached; and (6) all of the data has been processed.

One skilled in the art shall recognize that: (1) certain steps may optionally be performed; (2) steps may not be limited to the specific order set forth herein; (3) certain steps may be performed in different orders; and (4) certain steps may be done concurrently.

Any headings used herein are for organizational purposes only and shall not be used to limit the scope of the description or the claims. Each reference/document mentioned in this patent document is incorporated by reference herein in its entirety.

It shall be noted that any experiments and results provided herein are provided by way of illustration and were performed under specific conditions using a specific embodiment or embodiments; accordingly, neither these experiments nor their results shall be used to limit the scope of the disclosure of the current patent document. “Neural network” includes any neural network known in the art.

A service, function, or resource is not limited to a single service, function, or resource; usage of these terms may refer to a grouping of related services, functions, or resources, which may be distributed or aggregated. The use of memory, database, information base, data store, tables, hardware, and the like may be used herein to refer to system component or components into which information may be entered or otherwise recorded. The terms “data,” “information,” along with similar terms may be replaced by other terminologies referring to a group of bits, and may be used interchangeably. Any headings used herein are for organizational purposes only and shall not be used to limit the scope of the description or the claims. All documents cited herein are incorporated by reference herein in their entirety.

It shall also be noted that although embodiments described herein may be within the context of deep learning, aspects of the present disclosure are not so limited. Accordingly, aspects of the present disclosure may be applied or adapted for use in other contexts

### Analog AI Deep Learning

Solutions for analog AI deep learning may include a crossbar array and a crossbar ADC according to various embodiments of the invention. At the heart of crossbar arrays for analog deep learning are programmable resistors, which serve a similar foundational role to transistors in digital processors. By arranging arrays of programmable resistors in intricate layers, researchers can construct networks of analog artificial “neurons” and “synapses” that perform computations akin to those in a digital neural network. These networks can be trained to execute sophisticated AI tasks such as image recognition and natural language processing. The use of programmable resistors dramatically accelerates the training process of neural networks while substantially lowering the associated costs and energy consumption. As used herein, “analog AI deep learning” may be considered equivalent to “analog deep learning”.

Analog deep learning can outperform its digital counterpart in terms of speed and energy efficiency by orders of magnitude for at least two reasons. First, computation is conducted directly in memory, eliminating the need to transfer vast amounts of data back and forth between memory and a processor. Second, analog processors inherently support parallel operations. As the matrix size increases, an analog processor can handle the additional computations without requiring more time, since all operations occur simultaneously. This technology is particularly useful in applications where processing time and low power consumption are crucial, such as in training large language models (LLMs).

A high-performance analog to digital converter (ADC) plays a critical role in the overall system performance of an analog deep learning system by efficiently converting continuous analog signals from an analog crossbar array network to discrete digital signals, which then can be processed by the digital portions of a neural network circuit.

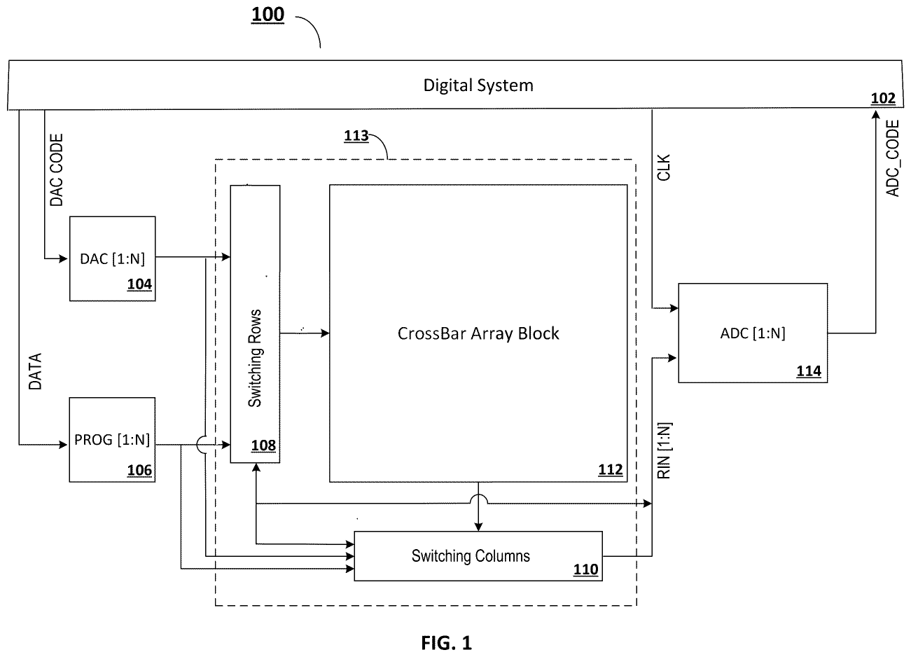

FIG. 1 depicts a generalized analog AI system 100, according to embodiments of the present disclosure. As used herein, “analog AI system 100”, may be referred to as system 100. System 100 can be utilized to implement an analog AI deep learning system. System 100 may be considered a deep learning training accelerator. System 100 may comprise digital system 102, digital-to-analog converters DAC [1:N] 104, programming module PROG [1:N] 106, switching rows 108, switching columns 110, crossbar array block 112 and an analog converter, ADC [1:N] 114. Crossbar array block 112 may be considered as a portion of a neural network operating in the analog domain and may have a N×M structure. In other embodiments, the crossbar array block 112 may be in a N×N structure. Per FIG. 1, analog crossbar array network 113 may comprise switching rows 108, switching columns 110 and crossbar array block 112. As used herein, analog crossbar array network 113 may be referred to as a “crossbar array”. As used herein, “ADC [1:N] 114” may be referred to as “ADC 114”. The crossbar array block 112 may comprise a matrix of the programmable nodes, which supports asynchronous neural network training utilizing parallel processing. Also, the switching rows 108 and the switching columns 110 receive respective data signals from the DAC 104 and control signals from the programming module 106, and output respective switched data to the matrix of the programmable nodes of the crossbar array block 112.

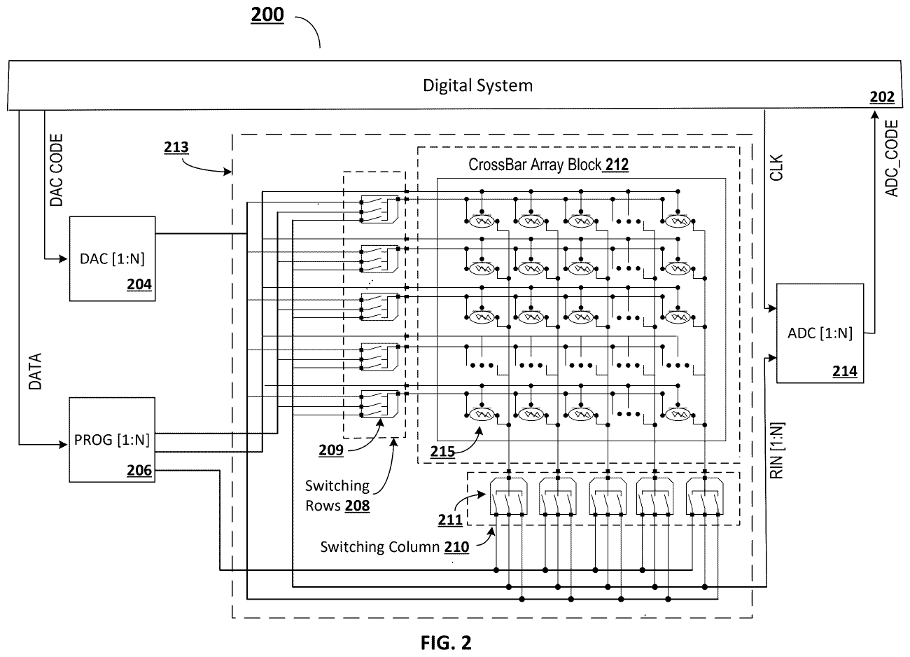

Digital system 102 comprises digital signals that may be parallel processed by analog crossbar array network 113. Specifically, DAC 104 may receive digital inputs, such as a DAC CODE, from digital system 102. The programming module 106 (e.g., PROG [1:N]) may provide settings for incrementally (positively or negatively) controlling the weight values for programmable components within crossbar array block 112. The programmable components may be referred to as programmable resistors or memristors. Switching rows 108 and switching columns 110 may comprise switches that control the parallel processing conducted by crossbar array block 112. ADC 114 may receive an ADC input (e.g., RIN [1:N]), which may be an analog current signal generated from collective outputs of switching rows 108 and switching columns 110 that are generated by crossbar array block 112. ADC 114 may also receive a clock signal, CLK, and generate a digital output, such as an ADC_CODE, which is coupled to digital system 102. The ADC input (e.g., RIN [1:N]) is generated based on a parallel impedance of the rows and/or columns within crossbar array block 112. Note that the rows and columns of nodes in the crossbar array block 112 are different than rows and columns in switching rows 108 and switching columns 110. The elements DAC 104 and ADC 114 may have values of [1:N] as indicated in FIG. 1. Programming module 106 is referenced on FIG. 1 as PROG [1:N] 106 . . . . ADC input (e.g., RIN [1:N]) may be considered an analog machine learning output signal. Similar references apply to the equivalent elements in FIG. 2. The aforementioned functions will be further discussed relative to FIG. 2.

FIG. 2 depicts an analog AI system 200, according to embodiments of the present disclosure. As used herein, “analog AI system 200”, may be referred to as system 200. System 200 may be considered an embodiment of system 100 shown in FIG. 1. As illustrated, the following blocks of system 100, digital system 102, DAC 104, programing module 106, and ADC 114, are both structurally and functionally broadly defined components of the system and the following components in FIG. 2 are examples thereof, as shown in system 200 comprising digital system 202, DAC 204 (e.g. DAC [1:N), programmable module 206 (e.g. PROG [1:N]), ADC 214 (e.g. ADC [1:N]). Per FIG. 2, analog crossbar array network 213 may comprise crossbar array block 212, switching rows 208 and switching columns 210. Analog crossbar array network 213 may also include: 1) switch 209, which may be a component of switching rows 208; 2) switch 211, which may be a component of switching columns 210; and 3) memristor 215, which may be a component of the crossbar array block 212. Memristor 215 may be considered to be a programmable resistor.

In the following paragraphs, these subjects will be discussed: core element, matrix multiplication, memristors, programming module, forward/backward/updating phases, and control lines.

Systems 100/200 may be utilized to implement a chip for an AI training accelerator. Core elements may include: semiconductor level blocks, which include proton gate transistors, an analog block with cross point array and ADC, and a digital block.

“Crossbar arrays” implemented in analog AI offer significant benefits compared with digital solutions. A procedure using basic matrix multiplication includes selecting inputs, and then multiplying the inputs together, and repeating the operations and multiplication many times and then adding the results. With methods implemented with an analog AI system, e.g., systems 100/200, the system converts the inputs into analog voltages. An analog voltage is applied across the analog crossbar array network 113/213, after which a multiplication vector is applied by a crossbar array block 112/212 using cross point elements, e.g., memristors, allowing in a single operation a full vector matrix multiplication result. The method can be extremely fast compared with basic matrix multiplication utilizing digital computer processing. Importantly, the method does not require fetching weights from a memory, as the weights were calculated and applied in real-time. Because the method is analog, a corresponding current is created at each node based on the applied voltage which allows these currents to be summed within the crossbar array block 212.

In certain embodiments, the summation of currents occurs at the bottom of the crossbar array block 212. The result is a sum of products for each one of these columns. The results are simultaneous, and none of the weights were moved from a memory into an ALU, and then executed like a multiplication using a digital multiplier, as may occur with a digital computer system. With a digital computer system, at the very least, this process may require movement of 200 transistors. And by some other estimates, there may be between 200 and 300 transistors that may be replaced by these cross-point elements. Accordingly, a solution with analog crossbar arrays can be extremely efficient from an energy perspective, and from a throughput perspective as analog crossbar arrays are significantly faster than their digital counterparts.

Relative to system 100/200, the output from the analog crossbar array network 112/213 (e.g., RIN [1:N]) is an analog current signal that is an input to ADC [1:N] 114/214, which measures the value of the analog signal and converts it to a digital value. Analog-to-digital converters (ADCs) can serve as a critical bridge between the analog world and the digital domain, making them essential for determining the performance of analog deep learning systems. They play a pivotal role in converting continuous analog signals into discrete digital values, which are then processed by the neural network. Their role in preserving precision, minimizing power consumption, and ensuring low-latency operation is crucial for the practical implementation of analog deep learning in real-world applications. ADC 114/214 may comprise a switch module, a first capacitor, a second capacitor, two trigger functions and a digital filter, wherein the switch module time interleaves the analog neural network output signal between two separate capacitive paths that are based on the first capacitor and the second capacitor, respectively.

Effectively, RIN [1:N] represents the value of the matrix multiplication from the analog crossbar array network 113/213. Nodes within the crossbar array block 212 are processed and updated using three processes performed in parallel: namely a forward pass, a backwards pass and an update procedure. For the forward pass, inputs are fed into rows and corresponding outputs are received from columns. For the backward pass, the input ports and output ports are swapped, where inputs are fed into columns and corresponding outputs are received from rows. An update pass is performed on one or more nodes in which the set of weight values is updated on the node based on errors backpropagated during the training process. Details about the forward and backward passes will be further discussed below. As used herein, the forward, backward, update procedures may be referred to as a pass, a path, a process, a phase, or an operation. For example, a forward pass, a forward path, the forward process, the forward phase, a forward operation.

Analog weight values are maintained and updated on each node using memristors. A memristor is a circuit device that defines the relationship between magnetic flux and electric charge. It functions similarly to a resistor but with a key difference: its resistance varies based on the charge that flows through it. This property allows the memristor to remember the amount of charge, effectively giving it memory capabilities, e.g. for representing network parameters, i.e., weights. The development of nano-memristor devices may enable non-volatile random-access memory, offering advantages in integration, power consumption, and read/write speeds compared to traditional random-access memory. Memristors can be particularly well-suited for implementing artificial neural network synapses in hardware, making them a promising technology for advanced computing applications.

In system 200, a digital input (e.g., DAC CODE) may be converted to an analog input for submission to crossbar array block 212 via switching rows 208 and/or switching columns 210. At each of the nodes in crossbar array block 212, there are weights stored by a cross-point element, (e.g., memristor 215). A memristor device may be considered a cross between a transistor and a resistor with the ability to store weights in an analog node such that memristor 215 is a programmable resistor, where the conductance value can be fine-tuned in an incremental fashion and represents the weight itself. Therefore, when a voltage is applied, the voltage is multiplied with conductance, and the input gets multiplied with a weight value.

Thus, one may adjust weights across the crossbar array block 112/212 by effectively tuning resistance on a particular node to change the weight value. One skilled in the art will recognize that the device conductances can be updated in a fully parallel manner inside that array, rather than updating column by column, or row by row. Hence, the output of the rows and/or columns of the crossbar array block 112/212 is an analog neural network output signal. The analog neural network output signal may also be referred to as a parallel impedance signal.

A separate programming module can provide programming to train and generate weight values. In response to identifying the weight values, control signals may be generated to set the resistance on that node. The weight is realized in an analog form across that node. As previously noted, the programming module 206 generates control lines that are respectively coupled to switching rows 208, including switch 209, and switching columns 210, including switch 211, which allow weight values on specific nodes to be individually addressed and managed.

As previously discussed, the operation of a “crossbar array” per system 100/200 may have three phases: forward/backward/update in accordance with various embodiments of the invention. A first transmission through the “crossbar array” may be considered a forward path that is used for forward pass training. After a training process reaches an end of the network, an error signal with respect to the loss function may be generated that is used to update the network. If there is a loss function, then the loss function may be used to compute one or more gradients using a backward pass to identify errors and update and improve accuracy of the neural network. In certain embodiments, DAC switches within columns may be used to drive a backwards training pass.

FIG. 1 and FIG. 2 comprise programming modules that are responsible for weight updates. In this example, these programming modules are illustrated as PROG [1:N] 106 and PROG [1:N] 206. Weights may be updated based on the three operation phases: forward, backward and update.

For example, training may occur using the forward path to perform calculations at nodes, a corresponding backward path may be used to identify one or more errors associated with the calculations and updates of weights at the nodes are provided to improve the accuracy of the subsequent calculations at one or more of the nodes. This process is repeated until the neural network is satisfactorily trained. In certain embodiments, once an accuracy target is reached, the weights are read through another algorithm such that conductance values are extracted and subsequently converted to digital values. These digital values may be identified as weights that can be stored in regular matrices on an inference processor, or as starting values for subsequent training.

As previously noted, programming modules 106/206 provide control lines that are coupled to switching rows 208 and switching columns 210. In this example, switch 209 of switching rows 208 has three switches that are involved to determine the operation phase. If a switch is designated in one direction, then a forward pass mode is implemented. Comparatively, another switch could close causing a backwards pass to be implemented. Furthermore, another of the switches in the block controls the updates. As previously noted, programming modules 106 and 206 are responsible for settings for adjusting the weights for this block.

Control lines are coupled into each one of those nodes, effectively instructing in defining weight values on each of the nodes on an increment or decrement basis. Considering the “crossbar array” as a whole, if a neural network training group is implemented, then the first phase can be a forward pass, and then a backward pass, then a multiply accumulate (i.e., update).

In certain embodiments, the output of the switches of switching rows 208 and switch columns 210 are coupled to the matrix of memristors of crossbar array block 212. Connectivity between crosspoint nodes, including the lines that go to the gates and the lines that go to the sources, provide dynamic pathways to enable algorithms that basically change each and every crosspoint parameter, such as the weights, by an incremental manner in the update cycle. This process then repeats the sequence again with a new forward, backwards, update cycle. A crosspoint node may be considered equivalent to a programmable node.

In summary, various embodiments of the analog-based machine learning system, a “crossbar array”, per system 100/200, as a part of a neural network, operates in the analog domain. Each of these nodes is performing mathematical calculations that need to be executed. Inputs are then applied to the weights to realize the calculations, and then the crossbar array couples the outputs in the analog domain to the ADC. The result is a digital output from the crossbar array processing architecture.

One skilled in the art will recognize that this functional and structural description of an ADC that converts an analog signal from an analog-based neural network into a digital signal represents an embodiment of the invention. Variations to this embodiment, both structurally and functionally may also be implemented in accordance with the invention.

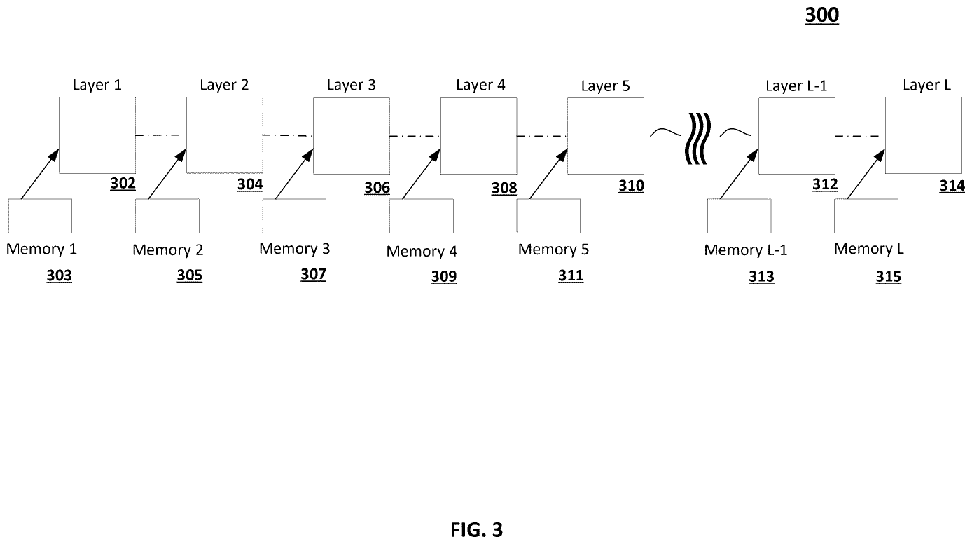

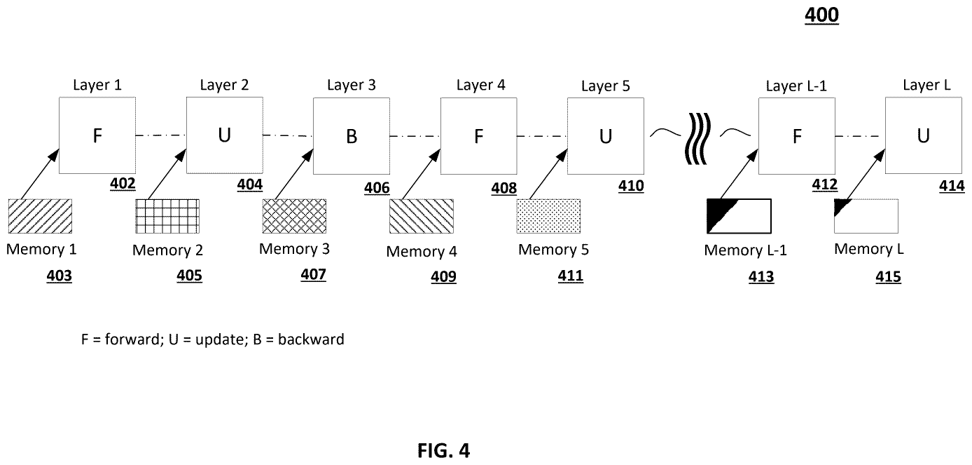

FIG. 3 and FIG. 4 depict exemplary block diagrams for asynchronous neural network training utilizing parallel processing within a crossbar network supporting a deep neural network, according to various embodiments of the present disclosure. FIG. 3 comprises pipeline 300 comprising a sequence of L layers including Layer 1 302, Layer 2 304, Layer 3 306, Layer 4 308, Layer 5 310, Layer L−1 312, and Layer L 314. Each of the L layers are separately coupled to the higher layer via pipeline 300. As illustrated in FIG. 3, pipeline 300 also comprises L memories, Memory 1 303, Memory 2 305, Memory 3 307, Memory 4 309, Memory 5 311, Memory L−1 313, and Memory L 315. In certain embodiments, each memory supports its respective layer. For example, Memory 1 303 supports Layer 1 302 as shown on FIG. 3.

FIG. 4 depicts pipeline 400 in operation and comprises L layers and L memories in a similar manner as FIG. 3, including layers 402, 404, 406, 408, 410, 412, 414, and memories 403, 405, 407, 409, 411, 413 and 415. Each layer of an L-layer neural network may be conducting either of the forward, backward and update operations at the same time. See FIG. 4, F=forward; U=update; B=backward. After 3*L timesteps and onwards, all layers of the network will be active processing a different microbatch of input with different operations. In order for the gradient calculations to be correct, the memory associated with each layer must hold L past histories of the inputs, resulting in a O(L) memory complexity, layer-wise. In certain embodiments, the memory maybe utilized to keep coefficients that can reconstruct the input history, as opposed to the history itself, thereby reducing the memory requirements to a constant level. As shown in FIG. 4, each of the L memories may have different values. In summary, FIG. 4 demonstrates a method for asynchronous neural network training with asymptotically 100% hardware utilization and order O(1) layer-wise memory complexity.

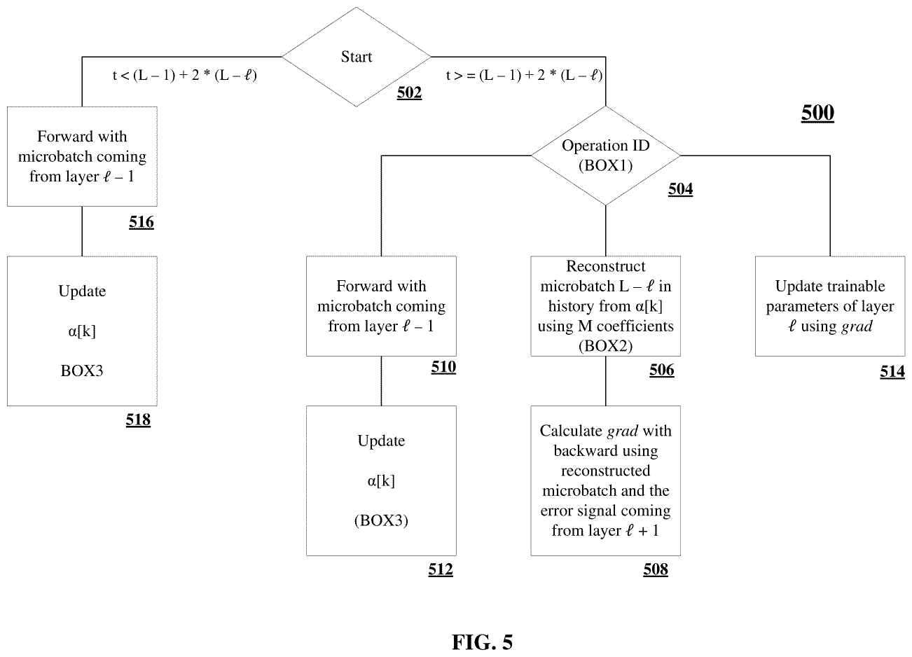

FIG. 5 depicts a flowchart 500 illustrating a method for parallel processing within the crossbar network supporting a deep neural network, according to various embodiments of the present disclosure. A challenge can be to keep the crossbar arrays “loaded” and performing one of the three fundamental operations, forward/backward/update, as continuously as possible. In addressing this challenge, embodiments of the invention may implement a method comprising the following steps:

First, the method includes comparing a time t to a time parameter T that is based on the number of layers L and a layer number [symbol] where a state is determined. As calculated, the time parameter T may be equal to (L−1)+2*(L− [symbol] ). (Step 502).

If time t<(L−1)+2*(L− [symbol] ), then the method proceeds with a forward operation: Forward with microbatch coming from layer [symbol] −1, where [symbol] specifies the particular layer number. (Step 516). Next, an update operation of α[k] with new samples x[n] can occur, per BOX 3. (Step 518).

BOX 3
BOX 3

```
    Updating a[k] with new samples x[n]
Edit new sample in the training set x[n] will update
a[k] k=1..M, so that the reconstruction loss up to N
history is minimized. For example, when we use
periodic complex exponentials as basis functions (like
Discrete Fourier Transform) the a[k] can be updated
by
  a[k] = x_{new} + a[k]exp(−2πjk/N)
```

If time t>=(L−1)+2*(L− [symbol] ), the operation for Layer [symbol] , at time t may be based on BOX 1. (Step 504). s(t, [symbol] ) is the operation state of layer [symbol] at time t, outputting whether to perform the forward, backward, or update operation.

BOX 1

Operation for Layer I, at time step t
$s ( t , l ) = ( t - 3 ⌊ \frac{t}{3} ⌋ + 2 l ) mod 3 ∀ t > 3 ( L - 1 )$

For the first case for Step 504, the method proceeds with a forward operation: Forward with microbatch coming from layer [symbol] −1, where [symbol] specifies the particular layer number. (Step 510). Next, an update operation of α[k] with new samples x[n] may occur, per BOX 3. (Step 512).

For the second case for Step 504, for a backward operation, the method proceeds with a reconstruction of microbatch: Reconstruct microbatch L− [symbol] in history from α[k] using M coefficients, as detailed in BOX 2. (Step 506).

BOX 2
Utilization of M coefficients to reconstruct
N history samples
x[n], n = 1. N can be reconstructed perfectly with N
coefficients and the set of basis functions phl(k,n). In
this example x[0] can denote the current sample and
x[N] can denote the Nth past sample.
$x [ n ] = {\sum }_{k = 0}^{N - 1} a [ k ] {Φ}_{k , n}$
Similarly the set of N coefficients a[k] can be obtained
from N samples.
$a [ k ] = {\sum }_{n = 0}^{N - 1} x [ n ] {ϕ}_{k , n}$
Provided x[n] is not purely random, an approximation
of x[n] can be obtained using M < N coefficients with a
minimal reconstruction loss.
$\tilde{x} [ n ] = {\sum }_{k = 0}^{M - 1} a [ k ] {Φ}_{k , n}$

Then, in a next step for a backward operation: Calculate a gradient with backward process using reconstructed microbatch and the error signal coming from layer [symbol] +1. (Step 508)

For the third case for Step 504, to support an update operation, the method proceeds to: Update trainable weights of layer [symbol] using the gradient. (Step 514).

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system for an analog neural network. The system also includes a digital-to-analog converter (DAC); a programming module that provides programming via control signals to train and set weight values in an analog form for programmable nodes of an analog crossbar array network; the analog crossbar array network that may include a crossbar array block, switching rows and switching columns; the crossbar array block that may include a matrix of the programmable nodes, which supports asynchronous neural network training utilizing parallel processing; the switching rows and the switching columns that receive respective data signals from the DAC and control signals from the programming module, and output respective switched data to the matrix of the programmable nodes of the crossbar array block; an analog-to-digital converter (ADC) that generates a digital signal based on an analog neural network output signal received from the switching rows and switching columns of the crossbar array; and a digital system that provides a DAC code to the DAC and provides a data signal to the programming module, and receives the digital signal from the ADC. Other embodiments of this aspect include corresponding computer systems, apparatus, and computer programs recorded on one or more computer storage devices, each configured to perform the actions of the methods.

One general aspect includes a system for asynchronous neural network training. The system also includes a neural network pipeline may include L layers and L memories, where each of the L layers are separately coupled to the higher layer via the neural network pipeline, where each layer of the L layers is configured to conduct either of a forward, a backward and an update operation at the same time, where after 3*L timesteps and onwards, all layers of the neural network pipeline are actively processing a different microbatch of inputs with different operations. Other embodiments of this aspect include corresponding computer systems, apparatus, and computer programs recorded on one or more computer storage devices, each configured to perform the actions of the methods.

One general aspect includes a non-transitory computer-readable medium or media may include one or more sequences of instructions which. The non-transitory computer-readable medium also includes determining a time parameter T based on number of layers L and a layer number [symbol] where a state is determined; and determining a forward, backwards or update operation based on the time parameter t relative to a time t. Other embodiments of this aspect include corresponding computer systems, apparatus, and computer programs recorded on one or more computer storage devices, each configured to perform the actions of the methods.

### Computing System Embodiments

In one or more embodiments, aspects of the present patent document may be directed to, may include, or may be implemented on one or more information handling systems (or computing systems). An information handling system/computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, mobile device (e.g., personal digital assistant (PDA), smartphone, phablet, tablet, etc.), smartwatch, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, read only memory (ROM), and/or other types of memory. Additional components of the computing system may include one or more drives (e.g., hard disk drive, solid state drive, or both), one or more network ports for communicating with external devices as well as various input and output (I/O) devices, such as a keyboard, mouse, touchscreen, stylus, microphone, camera, trackpad, display, etc. The computing system may also include one or more buses operable to transmit communications between the various hardware components.

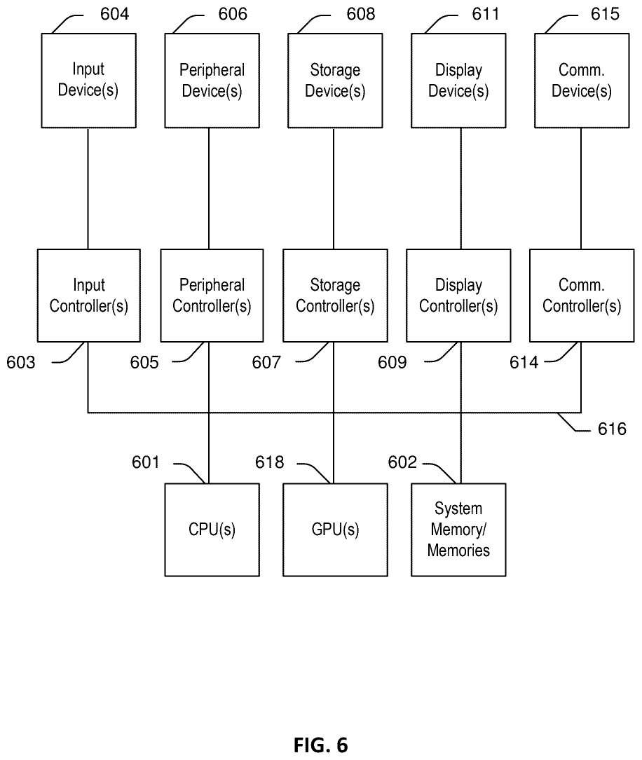

FIG. 6 depicts a simplified block diagram of an information handling system (or computing system), according to embodiments of the present disclosure. It will be understood that the functionalities shown for system 600 may operate to support various embodiments of a computing system, although it shall be understood that a computing system may be differently configured and include different components, including having fewer or more components as depicted in FIG. 6.

As illustrated in FIG. 6, the computing system 600 includes one or more CPUs 601 that provide computing resources and control the computer. CPU 601 may be implemented with a microprocessor or the like, and may also include one or more graphics processing units (GPU) 618 and/or a floating-point coprocessor for mathematical computations. In one or more embodiments, one or more GPUs 618 may be incorporated within the display controller 609, such as part of a graphics card or cards. The system 600 may also include a system memory 602, which may comprise RAM, ROM, or both.

A number of controllers and peripheral devices may also be provided, as shown in FIG. 6. An input controller 603 represents an interface to various input device(s) 604. The computing system 600 may also include a storage controller 607 for interfacing with one or more storage devices 608 each of which includes a storage medium such as magnetic tape or disk, or an optical medium that might be used to record programs of instructions for operating systems, utilities, and applications, which may include embodiments of programs that implement various aspects of the present disclosure. Storage device(s) 608 may also be used to store processed data or data to be processed in accordance with the disclosure. The system 600 may also include a display controller 609 for providing an interface to a display device 611, which may be a cathode ray tube (CRT) display, a thin film transistor (TFT) display, organic light-emitting diode, electroluminescent panel, plasma panel, or any other type of display. The computing system 600 may also include one or more peripheral controllers or interfaces 605 for one or more peripherals 606. Examples of peripherals may include one or more printers, scanners, input devices, output devices, sensors, and the like. A communications controller 614 may interface with one or more communication devices 615, which enables the system 600 to connect to remote devices through any of a variety of networks including the Internet, a cloud resource (e.g., an Ethernet cloud, a Fiber Channel over Ethernet (FCOE)/Data Center Bridging (DCB) cloud, etc.), a local area network (LAN), a wide area network (WAN), a storage area network (SAN) or through any suitable electromagnetic carrier signals including infrared signals.

In the illustrated system, all major system components may connect to a bus 616, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable media including, for example: magnetic media such as hard disks, floppy disks, and magnetic tape; optical media such as compact discs (CDs) and holographic devices; magneto-optical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices.

Aspects of the present disclosure may be encoded upon one or more non-transitory computer-readable media with instructions for one or more processors or processing units to cause steps to be performed. It shall be noted that non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that has computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as CDs and holographic devices; magneto-optical media; and hardware devices that are specially configured to store or to store and execute program code, such as ASICs, PLDs, flash memory devices, other non-volatile memory devices (such as 3D XPoint-based devices), and ROM and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

As those skilled in the art will appreciate, suitable implementation-specific modifications may be made, e.g., to adjust for the dimensions and shapes of the input data. The relatively small and square input data and kernel sizes, their aspect ratios, their orientations, and channel counts have been chosen for convenience of illustration and are not intended as a limitation on the scope of the present disclosure.

One skilled in the art will recognize no computing system or programming language is critical to the practice of the present invention. One skilled in the art will also recognize that a number of the elements described above may be physically and/or functionally separated into sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A system for an analog neural network comprising:
a digital-to-analog converter (DAC);
a programming module that provides programming via control signals to train and set weight values in an analog form for programmable nodes of an analog crossbar array network;
the analog crossbar array network that comprises a crossbar array block, switching rows and switching columns;
the crossbar array block that comprises a matrix of the programmable nodes, which supports asynchronous neural network training utilizing parallel processing;
the switching rows and the switching columns that receive respective data signals from the DAC and control signals from the programming module, and output respective switched data to the matrix of the programmable nodes of the crossbar array block;
an analog-to-digital converter (ADC) that generates a digital signal based on an analog neural network output signal received from the switching rows and switching columns of the crossbar array; and
a digital system that provides a DAC code to the DAC and provides a data signal to the programming module, and receives the digital signal from the ADC.

2. The system of claim 1 wherein each programmable node comprises a memristor, wherein a memristor resistance varies based on a charge that flows through the memristor, and allows the memristor to store an amount of charge.

3. The system of claim 1 wherein the ADC comprises a switch module, a first capacitor, a second capacitor, two trigger functions and a digital filter, wherein the switch module time interleaves the analog neural network output signal between two separate capacitive paths that are based on the first capacitor and the second capacitor, respectively.

4. The system of claim 1 wherein an analog voltage from the switching rows and switching columns is applied across the analog crossbar array network, after which a multiplication vector is applied by the crossbar array block using cross point elements, allowing a full vector matrix multiplication result in a single operation.

5. The system of claim 1, wherein programmable nodes within the crossbar array block are processed and updated using three processes performed in parallel: a forward pass, a backwards pass and an update procedure.

6. The system of claim 5 wherein for the forward pass, inputs are fed into rows and corresponding outputs are received from columns.

7. The system of claim 5 wherein for the backward pass, input ports and output ports are swapped, where inputs are fed into columns and corresponding outputs are received from rows.

8. The system of claim 5 wherein an update pass is performed on one or more nodes in which the set of weight values is updated on the node based on errors backpropagated during the training process.

9. The system of claim 5 wherein connectivity between programmable nodes, including lines that are coupled to gates and lines that are coupled to sources, provide dynamic pathways to enable algorithms that change programmable node parameters, such as weights, by an incremental manner in an update cycle, wherein the process then repeats a sequence again with a new forward, backwards, update cycle.

10. The system of claim 5 wherein a first transmission through the crossbar array block is the forward pass that is used for forward pass training, wherein after the forward pass training process reaches an end of a network, an error signal with respect to a loss function is generated, wherein the loss function is used to update the network by computing one or more gradients using the backward pass to identify errors and update and improve accuracy of the neural network.

11. A system for asynchronous neural network training comprising:
a neural network pipeline comprising L layers and L memories,
wherein each of the L layers are separately coupled to the higher layer via the neural network pipeline,
wherein each layer of the L layers is configured to conduct either of a forward, a backward and an update operation at the same time,
wherein after 3*L timesteps and onwards, all layers of the neural network pipeline are actively processing a different microbatch of inputs with different operations.

12. The system of claim 11 wherein to support gradient calculations, the L memories associated with each L layer saves L layers of past history of the inputs, resulting in an order O(L) memory complexity, layer-wise.

13. The system of claim 11 wherein the L memories are utilized so coefficients reconstruct input history, to reduce memory requirements to a constant level.

14. The system of claim 11 wherein each of the L memories are configured to have different values.

15. A non-transitory computer-readable medium or media comprising one or more sequences of instructions which, when executed by at least one processor, causes steps for parallel processing within a crossbar network, supporting a deep neural network comprising:
determining a time parameter T based on number of layers L and a layer number [symbol] where a state is determined; and
determining a forward, backwards or update operation based on the time parameter T relative to a time t.

16. The non-transitory computer-readable medium or media of claim 15 wherein,
if the time t is less than the time parameter T, proceed with a forward operation with a microbatch coming from layer [symbol] −1, and update a[k] with new samples x[n].

17. The non-transitory computer-readable medium or media of claim 15 wherein,
if the time t is greater than the time parameter T, determine a s(t, l) value for layer L, at time t.

18. The non-transitory computer-readable medium or media of claim 16 wherein,
proceeding with a forward operation as follows: (1) Forward with microbatch coming from layer l−1, where & specifies a layer number, (2) compute an update value of α[k] with new samples x[n].

19. The non-transitory computer-readable medium or media of claim 16 wherein,
proceeding with a reconstruction of microbatch L− [symbol] in history from α[k] using M coefficients, wherein gradients are calculated with a backward operation using the reconstructed microbatch and an error signal coming from layer L+1.

20. The non-transitory computer-readable medium or media of claim 16 wherein,
proceeding with an update operation, where trainable weights of layer [symbol] are updated using gradients.
